(19) United States
(12) Patent Application Publication
(10) Pub. No.: US 2026/0348843 A1
(43) Pub. Date: Nov. 5, 2026

(54) INFRARED GAS SENSOR AND STATIONARY GAS DETECTION DEVICE

(71) Applicant: Riken Keiki Co., Ltd., Tokyo (JP)

(72) Inventors: Fumiyasu Osada, Kasukabe-shi (JP); Takashi Yoshikawa, Kasukabe-shi (JP)

(73) Assignee: Riken Keiki Co., Ltd., Tokyo (JP)

(21) Appl. No.: 19/721,259

(22) Filed: Jun. 26, 2026

Related U.S. Application Data
(63) Continuation of application No. PCT/JP2025/006826, filed on Feb. 27, 2025.

(30) Foreign Application Priority Data
Feb. 28, 2024 (JP) 2024-028395

(51) Int. Cl. G01N 21/3504; G01N 21/31

(52) U.S. Cl. CPC G01N 21/3504; G01N 21/314; G01N 2021/3166

(57) ABSTRACT

An infrared gas sensor has a light-emitting unit which radiates an infrared ray to a measurement region formed such that a gas to be detected flows outside a pressure-resistant explosionproof container disposed in the pressure-resistant explosionproof container having a light-transmitting window, wherein a light-receiving unit includes a measurement light-receiving sensor for receiving measurement light in an intermediate infrared region via a measurement light-receiving sensor and a reference light-receiving sensor for receiving reference light via a reference band-pass filter, and on an optical path between the light-emitting unit and the light-transmitting window, a long-pass filter which lowers a transmission rate of light from a visible region to a near-infrared region which transmits through the light-transmitting window is disposed. A stationary gas detection device includes the above-described infrared gas sensor.

### BACKGROUND OF THE INVENTION

### 1. Field of the Invention

The present invention relates to an infrared gas sensor with a measurement region opened into the air, and a stationary gas detection device including the infrared gas sensor.

### 2. Description of the Related Art

As a non-dispersive infrared absorption type gas sensor for detecting concentration of a gas to be detected by detecting a change amount of an infrared ray caused by absorption of the gas to be detected in a gas to be inspected (hereinafter, referred to as an “infrared gas sensor”), a gas sensor constituted such that high-speed response is made possible by releasing a measurement region into the air is publicly known (see U.S. Patent Application Publication No. 2001/0015408, for example).

In the infrared gas sensor described in U.S. Patent Application Publication No. 2001/0015408, an infrared light source, a measurement light-receiving sensor for detecting measurement light of a wavelength region including an absorption wavelength of the gas to be detected, and a reference light-receiving sensor for detecting reference light whose absorption rate of the gas to be detected is smaller than that of the measurement light are disposed in a housing having a light-transmitting window, and a reflecting member for reflecting the light radiated via the light-transmitting window is disposed outside the housing such that the reflecting member for reflecting the light radiated via the light-transmitting window forms a measurement region opened into the air between the housing and the reflecting member. On an optical path from the reflecting member to the measurement light-receiving sensor in the housing, a beam splitter is disposed so as to cause a part of the light to be reflected and to enter the reference light-receiving sensor and the other entire light is caused to be transmitted and to enter the measurement light-receiving sensor. In addition, the measurement light-receiving sensor and the reference light-receiving sensor usually include a band-pass filter for filtering measurement light and reference light, and are constituted to detect measurement light and reference light, respectively.

In addition, in the infrared gas sensor constituted as above, a gas sensor with such a constitution is also publicly known that a band-pass filter, which transmits light in a specific wavelength region, is disposed on an optical path from the infrared light source to the reflecting member in the housing, and the light in a specific wavelength region is selectively emitted to the measurement region (see EP 0457624A1, for example).

Thus, in a gas detection device on which an infrared gas sensor used in an explosive atmosphere is mounted, it is required that pressure-resistant explosionproof requirements such as intrinsic safety, explosionproof and the like are satisfied.

In recent years, when equipment using a light source that emits powerful energy is used, there is a concern that a peripheral explosive atmosphere might catch fire depending on light radiation characteristics of the light source and thus, requirements for prevention of fire by radiated light (light-radiation explosionproof requirements) are required to be satisfied.

In the infrared gas sensor constituted such that the measurement region as described above is opened into the atmosphere, since the light from the infrared light source is radiated to the outside of the housing, the light-radiation explosionproof requirements need to be satisfied.

There is a possibility that all those constituted including, for light emitted to the outside of the housing, a lens or a light-condensing optical system such as a reflector fall under the light-radiation explosionproof requirements. In addition, in the light-radiation explosionproof requirements, the product needs to satisfy required matters not by a usual driving voltage (or driving electric-current or driving electric-power) but by a driving voltage (or the driving electric-current or the driving electric-power) immediately before the product begins to malfunction.

Therefore, in order for the infrared gas sensor to satisfy the light-radiation explosionproof requirements, light energy radiated from the infrared light source at a failure of the product needs to be assumed.

### SUMMARY OF THE INVENTION

In general, an infrared light source used in an infrared gas sensor such as a lamp, an LED and the like is devised so that a failure such as disconnection, for example, does not occur and thus, a voltage (or an electric current or electric power) applied to the infrared light source immediately before the infrared light source begins to malfunction becomes higher, and energy of light radiated from the infrared light source becomes stronger.

This may be dealt with by including excessive power-failure protection in an electric circuit such as an electric-current and/or voltage limiter mounted between the infrared light source and a power supply, but since a circuit structure becomes complicated, extreme disadvantage may arise in product designs. Particularly, differently from a portable detection device driven by a battery, in the stationary detection device, a power supply (voltage) at the source to be supplied to a product is involved and thus, it is difficult to design an excessive-power failure protection circuit.

On the other hand, as the infrared gas sensor described in EP 0457624A1, by filtering the light radiated from the infrared light source by a band-pass filter and by emitting the same to the outside of the housing, it is considered that the light-radiation explosionproof requirements may be satisfied.

However, the band-pass filter selectively transmits light in a specific narrow wavelength region and thus, a light amount of the light radiated to the measurement region becomes smaller. In order to obtain stable gas detection performance, it is necessary to enlarge the light radiated to the light-receiving sensor. With a structure in which the light from the infrared light source is emitted to the outside after filtering by a band-pass filter, a problem may arise in that alignment (optical adjustment) of the light-receiving sensor becomes difficult, and a manufacturing cost becomes high. In order to increase the amount of light which reaches the light-receiving sensor, the size of the band-pass filter needs to be made larger, but since the band-pass filter itself is more expensive than the other optical filters, the manufacturing cost may be higher.

The present invention has been completed in view of the circumstances as above and has objects to provide an infrared gas sensor which can satisfy the light-radiation explosionproof requirements with a simple constitution and can reduce a manufacturing cost thereof and to provide a stationary gas detection device that can satisfy the light-radiation explosionproof requirements and is capable of high-speed response.

The infrared gas sensor of the present invention is an infrared gas sensor which detects concentration of a detection target gas by detecting, by a light-receiving unit, a light-amount change amount of an infrared ray radiated from a light-emitting unit, the light-amount change being caused by absorption of the detection target gas in a gas to be detected, the sensor including: a pressure-resistant explosionproof container having a light-transmitting window, wherein the light-emitting unit is disposed in the pressure-resistant explosionproof container, the light-emitting unit being constituted so as to radiate the infrared ray via the light-transmitting window to a measurement region formed such that the gas to be detected flows outside the pressure-resistant explosionproof container and is released into the atmosphere, and the light-receiving unit includes a measurement light-receiving sensor for receiving light via a band-pass filter which transmits measurement light in an intermediate infrared region including an absorption wavelength of the detection target gas, and a reference light-receiving sensor for receiving light via the reference band-pass filter which transmits the reference light of which absorption intensity by the detection target gas is smaller than that of the measurement light, and, on an optical path between the light-emitting unit and the light-transmitting window, a long-pass filter is disposed, which lowers the transmission rate of the light from a visible region to the near-infrared region, which transmits through the light-transmitting window, so as to solve the above-described problem.

In addition, the stationary gas detection device of the present invention is a stationary gas detection device including a device main-body having an explosionproof structure and a gas sensor detachably attached to the device main-body and solves the above-described problem by constituting the gas sensor by the above-described infrared gas sensor.

According to the present invention, since emission of the light from the visible region to the near-and the intermediate infrared region to outside of the pressure-resistance explosionproof container is suppressed, while a light amount required and sufficient for measurement light in a wavelength region absorbing the detection target gas and for reference light in a wavelength region with absorption intensity by the detection target gas is smaller than the measurement light, gas detection with absorption intensity by the detection target gas is absorbed, the energy of the light emitted to the outside of the pressure-resistant container can be suppressed small. Therefore, without providing excessive power-failure protection in an electric circuit such as an electric-current and/or a voltage limiter mounted between the infrared light source and the power supply but with such simple constitution that a long-pass filter is disposed, the infrared gas sensor can be constituted as the one which satisfies the expected light-radiation explosionproof requirements. Moreover, since the long-pass filter is more inexpensive that the band-pass filter, manufacture with an advantageous cost is made possible.

In addition, since the reflecting member is disposed outside the pressure-resistant explosionproof container such that a measurement region is formed between that and the light-transmitting window, size reduction can be promoted while an optical-path length which is required and sufficient for gas detection can be ensured. As a result, application of the gas sensor to the stationary gas detection device constituted capable of detachable attachment to the device main-body, for example, becomes preferable.

In addition, since the long-pass filter has a specific function, while the expected light-radiation explosionproof requirements are satisfied, a sufficient amount of light can be made to reach the measurement light-receiving sensor and the reference light-receiving sensor and thus, gas detection with high reliability can be performed reliably.

In addition, since a beam splitter is disposed on the optical path from the reflecting member to the measurement light-receiving sensor, an output of the measurement light-receiving sensor and an output of the reference light-receiving sensor can be used and thus, stable gas detection is made possible.

Furthermore, since the infrared gas sensor has a measurement region opened into the atmosphere, gas detection can be performed at a high speed, and a stationary gas detection device with a pressure-resistant explosionproof specification satisfying the light-radiation explosionproof requirements can be provided.

### BRIEF DESCRIPTION OF THE DRAWINGS

FIG. 1 is a cross-sectional diagram schematically illustrating a constitution of an infrared gas sensor according to an Embodiment;

FIG. 2 is a chart illustrating spectral radiance characteristics of black-body radiation; and

FIG. 3 is a block diagram illustrating an outline of a constitution in an example of a stationary gas detection device according to the present invention.

### DESCRIPTION OF THE PREFERRED EMBODIMENTS

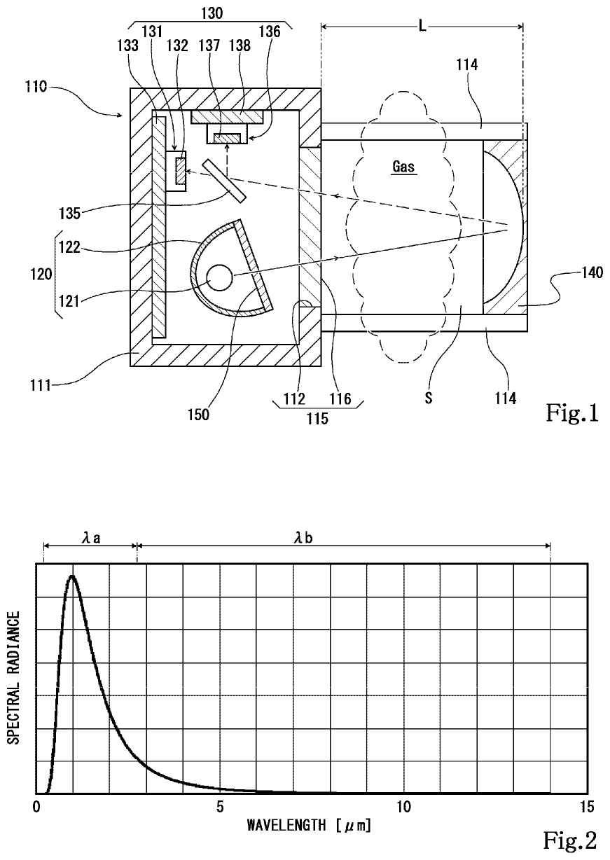

As shown in FIG. 1, an infrared gas sensor 110 according to this Embodiment is a non-dispersive infrared absorption type gas sensor of a single light-source and two-wavelength method and includes a pressure-resistant explosionproof container 111 having the light-transmitting window 115, a light-emitting unit 120 and a light-receiving unit 130 disposed in the pressure-resistant explosionproof container 111, and a reflecting member 140 disposed outside the pressure-resistant explosionproof container 111.

The pressure-resistant explosionproof container 111 is constituted by stainless steel, for example, and has an opening part 112 opened in one direction. On the opening part 112 of the pressure-resistant explosionproof container 111, a plate-shaped light-transmissive member 116 is provided so that the opening part 112 is blocked air-tightly, whereby the light-transmitting window 115 is constituted.

In this Embodiment, the light-transmissive member 116 is constituted by sapphire, for example, but as long as light in a wavelength region required for gas detection is transmitted and the expected explosionproof requirements can be satisfied, a material, a thickness and other specific constitutions are not particularly limited.

The light-emitting unit 120 includes an infrared light source 121 and a reflector 122 provided so as to surround a periphery of the infrared light source 121 and is constituted such that light radiated from the infrared light source 121 is reflected directly or by the reflector 122 and is emitted to the outside of the pressure-resistant explosionproof container 111 via the light-transmitting window 115.

The infrared light source 121 is not particularly limited as long as it is a light source which can output an infrared ray in a wavelength region including an absorption wavelength of the detection target gas, and a filament lamp, an LED or the like can be used, for example.

The light-receiving unit 130 includes a measurement light-receiving sensor 131 disposed at such a position that the light reflected by the reflecting member 140 on a wall surface opposing the light-transmitting window 115 in the pressure-resistant explosionproof container 111 can be received and a reference light-receiving sensor 136 disposed on a wall surface different from the wall surface on which the measurement light-receiving sensor 131 is disposed. The numeral 133 in FIG. 1 is a main substrate having a light-source driving circuit of the infrared light source 121 and an output processing circuit of the measurement light-receiving sensor 131, for example, and the numeral 138 is a sub substrate having an output processing circuit of the reference light-receiving sensor 136.

In this Embodiment, the measurement light-receiving sensor 131 includes a measurement band-pass filter 132 which transmits light for measurement in an intermediate infrared region including the absorption wavelength of the detection target gas, and it is constituted such that, when the light reflected by the reflecting member 140 is received via the measurement band-pass filter 132, the light for measurement is filtered. It is to be noted that the measurement light-receiving sensor 131 itself does not have to include the measurement band-pass filter 132, and the measurement band-pass filter 132 may be constituted to be disposed separately on an optical path from the reflecting member 140 to the measurement light-receiving sensor 131 in the pressure-resistant explosionproof container 111.

In addition, the reference light-receiving sensor 136 includes a reference band-pass filter 137 which transmits light for reference which is set in the intermediate infrared region and whose absorption intensity by the detection target gas is smaller than that of the light for measurement, and it is constituted such that, by means of reception of the light reflected by the reflecting member 140 via the reference band-pass filter 137, the light for reference is filtered.

By using a wavelength whose absorption intensity by the detection target gas is smaller than that of the measurement light as light for reference, the intensity difference between the light for measurement and the light for reference under the presence of the detection target gas becomes larger, and when a disturbance influence is reduced from the output of the measurement light-receiving sensor 131 by the output of the reference light-receiving sensor 136, it becomes possible to easily grasp a change in the output by the detection target gas. As the light for reference, it may be a wavelength without absorption by the detection target gas.

The reference light-receiving sensor 136 is also the case similar to that of the measurement light-receiving sensor 131, and it may be so constituted that the reference band-pass filter 137 is disposed separately on the optical path from the reflecting member 140 to the reference light-receiving sensor 136 in the pressure-resistant explosionproof container 111.

As described above, by including the measurement band-pass filter 132 and the reference band-pass filter 137 not on the light-emitting unit 120 side but on the light-receiving unit 130 side, the light amount of the light in the intermediate infrared region reaching the light-receiving unit 130 can be made larger. Therefore, a lens or a reflector with a complicated shape is not needed anymore, and an optical-path design to the measurement light-receiving sensor 131 and the reference light-receiving sensor 136 can be simplified. In addition, since the sizes of the measurement band-pass filter 132 and the reference band-pass filter 137 can be small, reduction of the manufacturing cost can be promoted.

On the optical path from the reflecting member 140 to the measurement light-receiving sensor 131 in the pressure-resistant explosionproof container 111, a beam splitter 135 which reflects a part of the light transmitted through the light-transmitting window 115 and causes it to be received by the reference light-receiving sensor 136 and transmits all the other parts and causes them to be received by the measurement light-receiving sensor 131 is disposed.

As described above, since the measurement light-receiving sensor 131 and the reference light-receiving sensor 136 disposed on the wall surfaces different from each other are constituted to receive the light, both the output of the measurement light-receiving sensor 131 and the output of the reference light-receiving sensor 136 can be used, and stable gas detection is made possible.

On the outer surface of the wall surface on which the light-transmitting window 115 in the pressure-resistant explosionproof container 111 is provided, a pair of rod-state support members 114 are provided upright and to extend in the above-described one direction at positions opposing each other with the light-transmitting window 115 between them.

The reflecting member 140 is supported by the support member 114 at a position separated by a predetermined distance in one direction from the light-transmitting window 115. As a result, between the pressure-resistant explosionproof container 111 and the reflecting member 140, a measurement region S opened into the atmosphere so that the gas to be detected flows outside the pressure-resistant explosionproof container 111 is formed. A maximum separation distance L between the outer surface of the light-transmitting window 115 and the reflection surface of the reflecting member 140 is set within a range of 20 to 40 mm, for example, and as a result, while an optical-path length with such a length that is required and sufficient for gas detection is ensured, size-reduction of the infrared gas sensor 110 is promoted.

In the above-described infrared gas sensor 110, on the optical path from the infrared light source 121 in the pressure-resistant explosionproof container 111 to the reflecting member 140, a long-pass filter 150 which lowers a transmission rate of the light from the visible region to the near-infrared region, which is transmitted through the light-transmitting window 115 or the light in the wavelength region of 0.38 μm to 3 μm, for example, is disposed, and mainly the light in a wavelength region of the intermediate infrared region is emitted to the outside of the pressure-resistant explosionproof container 111.

As the long-pass filter 150, it is preferable to use the one with light in the intermediate infrared region or with the transmission rate of the light in the wavelength with absorption of a flammable gas or CO₂, which is a measurement target gas, is 80% or more, for example. As a result, while the expected light-radiation explosionproof requirements are satisfied, light in a sufficient light amount can be made to reach the measurement light-receiving sensor 131 and the reference light-receiving sensor 136 and thus, gas detection with high reliability can be performed reliably.

Specifically, as the long-pass filter 150, it is more preferable to use the those with the light transmission rate in the wavelength region of 2.7 to 14.0 μm being 80% or more, those with the light transmission rate in the wavelength region of 3.0 to 4.5 μm being 80% or more, or those with the light transmission rate in the wavelength region of 4.5 to 14.0 μm being 80% or more, for example.

In addition, it is preferable that the long-pass filter 150 is the one with the light from the visible region to the near-infrared region or with the light transmission of 0.38 μm to 2.7 μm being 20% or less, for example. According to the long-pass filter 150 having the optical characteristics as above, the infrared gas sensor 110 can be constituted such that the expected light-radiation and explosionproof requirements are satisfied.

In the above, the detection target gas of the above-described infrared gas sensor 110 is a gas having an absorption wavelength in the intermediate infrared region and is a hydrocarbon gas such as methane and isobutane and the other flammable gases; toxic gas such as a carbon monoxide gas; or a carbon dioxide gas and the like, for example.

Thus, the infrared light source 121 used in the infrared gas sensor 110 has, as shown in FIG. 2, such a wavelength characteristic showing a peak intensity in a wavelength range λa from the visible region to the near-infrared region, and the light amount is larger than that of the light in a wavelength range λb used for the gas detection.

However, according to the above-described infrared gas sensor 110, since the long-pass filter 150 is disposed on the optical path from the infrared light source 121 to the reflecting member 140 in the pressure-resistant explosionproof container 111, emission to the outside of the pressure-resistant explosionproof container 111 of the light from the visible region to the near-infrared region is suppressed. Therefore, while a light amount which is required and sufficient for gas detection is secured for the light for measurement in a wavelength region in which the detection target gas is absorbed and the light for reference in a wavelength region with the absorption intensity by the detection target gas is smaller than that of the light for measurement, the energy of the light emitted to the outside of the pressure-resistant explosionproof container 111 can be suppressed small.

In actuality, when a filament lamp is used as the infrared light source, and irradiance (light energy) when magnitude of a voltage immediately before a failure is applied to the filament lamp is measured, as compared with the infrared gas sensor for comparison and not having a long-pass filter, it was confirmed that the irradiance at the lamp failure of the infrared gas sensor according to the present invention having the long-pass filter can be suppressed to the intensity of approximately ⅛.

As described above, according to the above-described infrared gas sensor 110, since the light energy emitted to the outside of the pressure-resistant explosionproof container 111 can be suppressed, without including an excessive power-failure protection in an electric circuit such as an electric-current and/or a voltage limiter mounted between the infrared light source 121 and the power supply but with such a simple constitution that the long-pass filter 150 is disposed, the infrared gas sensor 110 can be constituted as the one which satisfies expected light-radiation explosionproof requirements. Moreover, the long-pass filter is more inexpensive than the band-pass filter, and manufacture with advantageous costs is made possible without deteriorating the sensor performance.

The above-described infrared gas sensor 110 can be preferably used as a gas detection part of a stationary gas detection device with an explosionproof specification, for example.

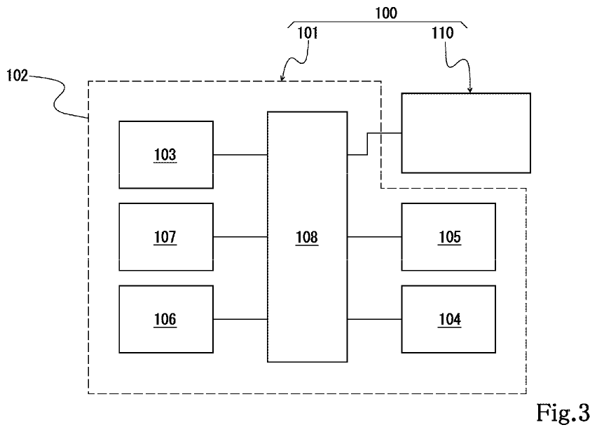

As shown in FIG. 3, the stationary gas detection device 100 is constituted by detachable attachment of the above-described infrared gas sensor 110 on the device main-body 101.

The device main-body 101 is constituted such that a power-supply part 103, an operation part 104, a display part 105, an alarm part 106, an external output part 107, an operation control part (CPU) 108, and other electric components are disposed in an explosionproof container 102, for example. The explosionproof container 102 is constituted by stainless-steel, for example.

According to the stationary gas detection device 100 as above, since the infrared gas sensor 110 has a measurement region opened into the atmosphere, gas detection at a high speed is made possible.

As described above, the Embodiment of the present invention has been explained, but the present invention is not limited to the above-described Embodiment, but various changes can be applied.

For example, in the above-described Embodiment, such explanation was made that the infrared gas sensor is constituted as a so-called “reflection-type”, but it may be also constituted as a so-called “straight-light type” in which the light-receiving unit and the light-emitting unit are opposed to each other. In such a case, it is only necessary to be constituted such that the light-receiving unit is also disposed in an explosionproof container having a light-transmitting window or the like, for example, in order to satisfy the pressure-resistant explosionproof requirements.

In addition, in those of the reflection type, designing of an optical system such as disposed positions of a light-source unit and the light-receiving unit in the pressure-resistant explosionproof container is not limited to those according to the above-described Embodiment, but it is only necessary that the light-receiving unit is disposed capable of receiving the light from the reflecting member.

What is claimed is:

1. An infrared gas sensor for detecting concentration of a detection target gas by detecting, by a light-receiving unit, a light-amount change amount of an infrared ray radiated from a light-emitting unit, the light-amount change being caused by absorption of the detection target gas in a gas to be detected,
the sensor comprising:
a pressure-resistant explosionproof container having a light-transmitting window, wherein
the light-emitting unit is disposed in the pressure-resistant explosionproof container, the light-emitting unit being constituted to radiate the infrared ray via the light-transmitting window to a measurement region formed such that the gas to be detected flows outside the pressure-resistant explosionproof container and is released into the atmosphere;
the light-receiving unit includes a measurement light-receiving sensor for receiving light via a measurement band-pass filter that transmits measurement light in an intermediate infrared region including an absorption wavelength of the detection target gas, and a reference light-receiving sensor which receives light via a reference band-pass filter which transmits reference light, of which absorption intensity by the detection target gas is smaller than that of the measurement light, and
on an optical path between the light-emitting unit and the light-transmitting window, a long-pass filter is disposed, which lowers a transmission rate of the light from a visible region which transmits through the light-transmitting window to the near-infrared region.

2. The infrared gas sensor according to claim 1, wherein
the light-receiving unit is disposed in the pressure-resistant explosionproof container, and
a reflecting member for reflecting light from the light-emitting unit toward the light-receiving unit is disposed outside the pressure-resistant explosionproof container such that the measurement region is formed between the reflecting member and the light-transmitting window.

3. The infrared gas sensor according to claim 1, wherein
the long-pass filter has a light transmission rate of 80% or more in a wavelength region of 2.7 to 14.0 μm.

4. The infrared gas sensor according to claim 2, wherein
on an optical path from the reflecting member to the measurement light-receiving sensor in the pressure-resistant explosionproof container, a beam splitter which reflects a part of light transmitted through the light-transmitting window and causes the part of light to be received by the reference light-receiving sensor and transmits all other parts thereof and causes all the other parts to be received by the measurement light-receiving sensor.

5. A stationary gas detection device comprising a device main-body having an explosionproof structure and including a gas sensor detachably attached to the device main-body, wherein
the gas sensor is constituted by the infrared gas sensor according to claim 2.
